(19) United States
(12) Patent Application Publication
(10) Pub. No.: US 2026/0131240 A1
(43) Pub. Date: May 14, 2026

(54) SYSTEMS AND METHODS FOR CONFLICT DETECTION

(71) Applicant: PLAYTIKA LTD., Herzliya Pituach (IL)

(72) Inventors: Kostiantyn SHYKUN, Kyiv City (UA); Illia BIEZHENUSOV, Warsaw (PL); Yuval MEY-TAL, Tel Aviv-Yafo (IL); Artem NAGRONYI, Herzliya Pituach (IL)

(73) Assignee: PLAYTIKA LTD., Herzliya Pituach (IL)

(21) Appl. No.: 19/385,135

(22) Filed: Nov. 10, 2025

Related U.S. Application Data
(60) Provisional application No. 63/718,160, filed on Nov. 8, 2024.

(51) Int. Cl. A63F 13/44; A63F 13/79

(52) U.S. Cl. CPC A63F 13/44; A63F 13/79

(57) ABSTRACT

A non-transitory computer readable medium containing instructions for conflict detection in time-limited gaming experience patch overlays is provided. Operations include receiving two separate time-limited gaming experience patch overlays via a remote platform for execution on a video game platform; determining interference between the overlays; comparing attributes of both overlays; identifying conflicts based on the comparison; and outputting an indication of the conflicts, wherein the video game platform is separate from the remote platform. Systems and methods for conflict detection are also provided.

### CROSS-REFERENCE TO RELATED APPLICATIONS

This application claims priority to U.S. Provisional Application No. 63/718,160, titled SYSTEMS AND METHODS FOR CONFLICT DETECTION, filed Nov. 8, 2024, which is hereby incorporated by reference in its entirety.

### FIELD OF THE DISCLOSURE

The present invention relates generally to video game platforms and, more specifically, to a system and method for detecting conflicts between different gaming experience patch overlays.

### BACKGROUND

Conflict detection in software systems has long been a challenge, particularly in dynamic environments where multiple components or modules interact. In the realm of video games and interactive entertainment, this challenge is amplified by the complexity of modern gaming platforms and the increasing demand for customizable, time-limited experiences.

Existing methods for managing game modifications often rely on static rule sets or manual oversight, which can be inadequate when dealing with rapidly changing, time-sensitive content. These approaches frequently struggle to identify potential conflicts between different game modifications, especially when those modifications are designed to be temporary or targeted at specific player segments.

Current systems for deploying game updates or modifications typically operate in isolation, without a comprehensive understanding of how multiple changes might interact. This can lead to unintended consequences, such as conflicting rewards, contradictory game mechanics, or technical issues that negatively impact the player experience.

Furthermore, the growing trend of live service games and seasonal content updates has created a need for more sophisticated tools to manage the deployment of time-limited features. Traditional patch management systems are often ill-equipped to handle the nuances of temporary modifications that may overlap or interact in complex ways.

The lack of robust conflict detection mechanisms in gaming platforms can result in a range of issues, from minor inconsistencies in gameplay to more serious problems like game crashes or data corruption. These issues not only frustrate players but can also lead to increased development costs and damage to a game's reputation.

Additionally, as games increasingly cater to diverse player bases with personalized experiences, the potential for conflicts between different player-specific modifications has grown. Existing systems struggle to effectively manage and reconcile these targeted changes, particularly when they intersect with broader, time-limited events or features.

The limitations of current approaches to managing game modifications become even more apparent in the context of remote content delivery and cloud gaming services. These platforms introduce additional layers of complexity in terms of timing, synchronization, and compatibility across different hardware configurations.

There is a need for more advanced systems and methods to address these challenges in the field of game development and live service management. Improved conflict detection and resolution mechanisms could significantly enhance the stability and consistency of gaming experiences, particularly in the context of time-limited and player-specific modifications.

With the growth of online gaming and the increasing complexity of player behavior, it has become important to customize and optimize the gaming experience for different types of players. For example, by analyzing various gaming experience patch overlays, as configured by one or more users, the disclosed systems and methods can enhance patch overlay generation and configuration, while simultaneously increasing player retention and monetization by enabling the seamless and error-free creation of altered gaming experiences for different players of a video game via a remote platform.

### BRIEF DESCRIPTION OF THE DRAWINGS

FIG. 1 illustrates an exemplary method for conflict detection, consistent with disclosed embodiments.

FIG. 2 illustrates an exemplary system for conflict detection, consistent with disclosed embodiments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one embodiment, a non-transitory computer readable medium containing instructions is provided. When executed by at least one processor, these instructions cause the at least one processor to perform conflict detection identification operations in time-limited gaming experience patch overlays. The operations include receiving via a remote platform a first time-limited gaming experience patch overlay for execution on a video game platform, separate from the remote platform; receiving via the remote platform a second time-limited gaming experience patch overlay for execution on the video game platform, separate from the remote platform; determining that the first time-limited gaming experience patch overlay interferes with the second time-limited gaming experience patch overlay; comparing attributes of the first time-limited gaming experience patch overlay with attributes of second time-limited gaming experience patch overlay; based on the comparing, determining an existence of at least one conflict between the first time-limited gaming experience patch overlay and the second time-limited gaming experience patch overlay; and outputting at least one indication of the at least one conflict.

In other embodiments, the first time-limited gaming experience patch overlay and the second time-limited gaming experience patch overlay may include developer-defined triggers and conditions, and may further include at least one action resulting from the triggers and conditions. The at least one action may include presentation of at least one reward and the at least one conflict may include presentation of multiple rewards for a common detected trigger. The at least one action may include presentation of at least one reward and the at least one conflict may include presentation of multiple rewards for a common detected condition. The at least one conflict may include contradictory triggers for a common reward. The operations may further include receiving a selection of a first group of players for application of the first time-limited gaming experience patch overlay and a second group of players for application of the second time-limited gaming experience patch overlay. The at least one conflict may include an identification of a same player in the first group and in the second group. The operations may further comprise suggesting a conflict resolution. The operations may further comprise predicting a potential impact of the at least one conflict, and outputting the prediction. The operations may further comprise analyzing player feedback, engagement metrics, or performance data to prioritize conflict resolution based thereon. The comparing may be performed in a sandbox computing environment. The comparing may be performed prior to execution on the video game platform of at least one of the first time-limited gaming experience patch overlay and the second time-limited gaming experience patch overlay. The operations may further comprise pausing the first time-limited gaming experience patch overlay and the second time-limited gaming experience patch overlay when the at least one conflict is identified, and resuming operation of the first time-limited gaming experience patch overlay and the second time-limited gaming experience patch overlay when the at least one conflict is resolved.

In another embodiment, a system for performing conflict detection identification operations in time-limited gaming experience patch overlays is provided. The system includes at least one processor configured to perform operations including receiving via a remote platform a first time-limited gaming experience patch overlay for execution on a video game platform, separate from the remote platform; receiving via the remote platform a second time-limited gaming experience patch overlay for execution on the video game platform, separate from the remote platform; determining that the first time-limited gaming experience patch overlay interferes with the second time-limited gaming experience patch overlay; comparing attributes of the first time-limited gaming experience patch overlay with attributes of second time-limited gaming experience patch overlay; based on the comparing, determining an existence of at least one conflict between the first time-limited gaming experience patch overlay and the second time-limited gaming experience patch overlay; and outputting at least one indication of the at least one conflict.

In other embodiments, the first time-limited gaming experience patch overlay and the second time-limited gaming experience patch overlay may include developer-defined triggers and conditions, and may further include at least one action resulting from the triggers and conditions. The at least one action may include presentation of at least one reward and the at least one conflict may include presentation of multiple rewards for a common detected trigger. The at least one action may include presentation of at least one reward, and the at least one conflict may include presentation of multiple rewards for a common detected condition. The at least one conflict may include contradictory triggers for a common reward. The operations may further include receiving a selection of a first group of players for application of the first time-limited gaming experience patch overlay and a second group of players for application of the second time-limited gaming experience patch overlay.

In yet another embodiment, a method of performing conflict detection identification operations in time-limited gaming experience patch overlays is provided. The method includes receiving via a remote platform a first time-limited gaming experience patch overlay for execution on a video game platform, separate from the remote platform; receiving via the remote platform a second time-limited gaming experience patch overlay for execution on the video game platform, separate from the remote platform; determining that the first time-limited gaming experience patch overlay interferes with the second time-limited gaming experience patch overlay; comparing attributes of the first time-limited gaming experience patch overlay with attributes of second time-limited gaming experience patch overlay; based on the comparing, determining an existence of at least one conflict between the first time-limited gaming experience patch overlay and the second time-limited gaming experience patch overlay; and outputting at least one indication of the at least one conflict.

The foregoing general description of the illustrative embodiments and the following detailed description thereof are merely exemplary aspects of the teachings of this disclosure and are not restrictive.

### DETAILED DESCRIPTION

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Generally, program modules include routines, programs, objects, components, data structures, and so forth, which perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

Exemplary disclosed embodiments include devices, systems, methods, and computer readable media for configuring varying gaming experiences based on group segmentation.

Some disclosed embodiments involve a non-transitory computer readable medium containing instructions that when executed by at least one processor cause the at least one processor to perform conflict detection operations in time-limited gaming experience patch overlays may be provided.

The term “perform” refers to the act of carrying out, executing, or accomplishing a specific operation, task, or set of instructions, e.g., as directed by a system or instructions. For example, in this context, “perform” may describe how a processor executes conflict detection identification operations, such as receiving patch overlays, comparing their attributes, identifying conflicts between them, and outputting indications of these conflicts. Additionally, “perform” may encompass executing gaming experience variation operations, like dynamic difficulty adjustment, event-driven changes, or applying time-limited patch overlays to enhance or modify the player's experience in a video game platform.

The term “conflict detection identification operations” refers to processes or procedures designed to identify and analyze potential conflicts or incompatibilities between different elements or components of a system. “Conflict detection identification operations,” in the present context, may refer to the systematic process of scanning and analyzing game data layers—such as mods, patches, or overlays—to identify overlapping or contradictory changes that could disrupt gameplay. The aim of these operations may be to detect when two or more modifications attempt to alter the same game element (e.g., assets, scripts, or UI components) within a constrained time frame, such as during a temporary event or patch cycle. The goal may be to flag conflicts early, classify their severity, and prepare resolution strategies so that the intended enhancements from the patch overlays integrate smoothly without causing crashes, missing features, or degraded performance. These operations may ensure compatibility and stability by identifying problematic overlaps before they impact the player's experience. For example, conflict detection identification operations may include comparing attributes, analyzing dependencies, or evaluating interactions between different components to determine if they may interfere with each other's functionality.

As a further example, if one patch overlay introduces a new reward at or after a particular in-game event (e.g., a login) and a second patch overlay introduces a different reward at the same in-game event (e.g., the same login), conflict detection identification operations may identify this overlap and/or determine how to correct or mitigate the resulting incompatibilities. The conflict detection operations may include, e.g., checking for overlapping files, scripts, or assets, and then either prioritizing one patch over another, merging changes (if possible), or alerting developers to the conflict for manual resolution. It will be understood that such operations are important for, e.g., maintaining gaming experience stability and ensuring that patch overlays work harmoniously without causing unintended gameplay issues.

A “gaming experience” refers to the overall interactive engagement a player has with a game, encompassing not just the mechanics of play but the complete sensory, emotional, and social dimensions of the activity. It may include the game's design, visuals, audio, narrative, and user interface, as well as the player's sense of immersion, enjoyment, and challenge. The term may also cover external factors such as community interaction, accessibility, and the way the game influences perceptions beyond the play session. It may refer to the holistic experience created by the combination of gameplay, presentation, and the surrounding ecosystem, aiming to deliver entertainment, engagement, and sometimes educational or social value. For example, a gaming experience may include signing up for a trial, registering as a player, playing a level, completing a stage, failing a stage, making a payment, receiving a payment or reward, or any other user interaction that might occur between the user and a video game or video game platform. An overall gaming experience may encompass a combination of elements that contribute to how enjoyable, immersive, and memorable a game is for the player of that game. The gaming experience may be shaped by various factors, including the game design, game mechanics, narrative, audiovisual presentation, and the player's personal preferences and context. The gaming experience may further be enhanced via gaming experience variation operations, as described herein.

The term “patch overlay(s)” refers to a temporary layer of updates or modifications applied on top of the existing game code or interface to introduce new features, fix issues, or adjust gameplay. Unlike a full patch that permanently alters the game, an overlay acts as an additional layer that coexists with the base game, often without replacing core assets. These overlays can include graphical elements, user interface enhancements, or event-specific mechanics, and they are designed to integrate seamlessly without disrupting the underlying game structure. Their purpose may be to enrich the player experience for a limited duration—such as seasonal events or promotional periods—while maintaining compatibility with the main game systems. In this context, patch overlays may refer to additional content or features introduced through a patch or update, wherein the additional content or features are configured to appear at specific points within the game, such as, e.g., after a login event, between levels, or during a transition between different portions of a game. Exemplary patch overlays may include side story elements, cutscenes, challenges, questions, rewards, notification, or other graphical elements that are overlaid onto the original gaming experience as provided by an associated video game platform.

In this context, “side story elements” may refer to narrative components or scenarios that exist alongside the main storyline of a game to provide additional background or character development. For example, side story elements might include optional quests that reveal more about a supporting character's past or unlock unique dialogue scenes.

In this context, “cutscenes” may refer to non-interactive cinematic sequences used to convey narrative, transition between gameplay segments, or highlight key moments within a game. For example, a cutscene might play after a major boss battle to show the aftermath or to introduce a new character.

In this context, “challenges” may refer to specific tasks, objectives, or obstacles presented to players that test their skills, strategy, or decision-making within the game. For example, challenges could include time-limited events requiring players to defeat a certain number of enemies or solve a puzzle under specific conditions.

In this context, “questions” may refer to prompts or queries posed to players, often as part of in-game events, trivia, or dialogue choices that influence gameplay outcomes. For example, questions might appear during a character interaction where the player must choose a response that affects the story's direction.

In this context, “rewards” may refer to in-game items, bonuses, or benefits granted to players for completing objectives, overcoming challenges, or participating in events. For example, rewards could include virtual currency, new equipment, or cosmetic items awarded after finishing a quest or achieving a milestone.

In this context, “notification” may refer to automated messages or alerts delivered to the player to inform them of important events, updates, or actions required within the game. For example, a notification might appear to announce the start of a time-limited event or to let the player know a new challenge is available.

In this context, “other graphical elements” may refer to visual components or enhancements added to the game's interface, environment, or presentation that are not part of the core gameplay mechanics. For example, other graphical elements might include special visual effects, themed backgrounds, or custom icons introduced during a seasonal event.

As an example, after a patch overlay is configured via a remote platform separate from an associated video game platform, new content might be added to include an additional narrative between levels, or new visual elements might be introduced that notify a user of a reward (either within the video game or with respect to another game). With a properly configured patch overlay, such new content may be integrated into an existing game to seamlessly blend with the original design.

The term “time-limited” refers to something that is available or accessible only for a specific period of time. For example, time-limited elements may include promotions, events, or features that are active for a predetermined duration before expiring or becoming unavailable. Time-limited, in this context, may refer to something that is available or accessible only for a specific period of time. Once this limited time period expires, the opportunity, event, or item may no longer be available. As an example, patch overlays, as disclosed herein, may be time-limited. Therefore, promotions, events, offers, challenges, or other content contained within a given configured patch overlay may require users or participants to engage with the additional content before a time period runs out.

In the context of the present disclosure, the phrase “performing conflict detection identification operations in time-limited gaming experience patch overlays” may refer to the process of analyzing and identifying potential conflicts or incompatibilities between different time-limited modifications or additions to a gaming experience. This may involve comparing attributes, evaluating interactions, or assessing dependencies between different patch overlays to ensure they do not interfere with each other or negatively impact the overall gaming experience.

By way of a non-limiting example, as described in detail below, performing conflict detection identification operations in time-limited gaming experience patch overlays may involve receiving multiple patch overlays via a remote platform, comparing their attributes, and determining if any conflicts exist between them. This process may help maintain the integrity and consistency of the gaming experience while allowing for dynamic, time-limited modifications.

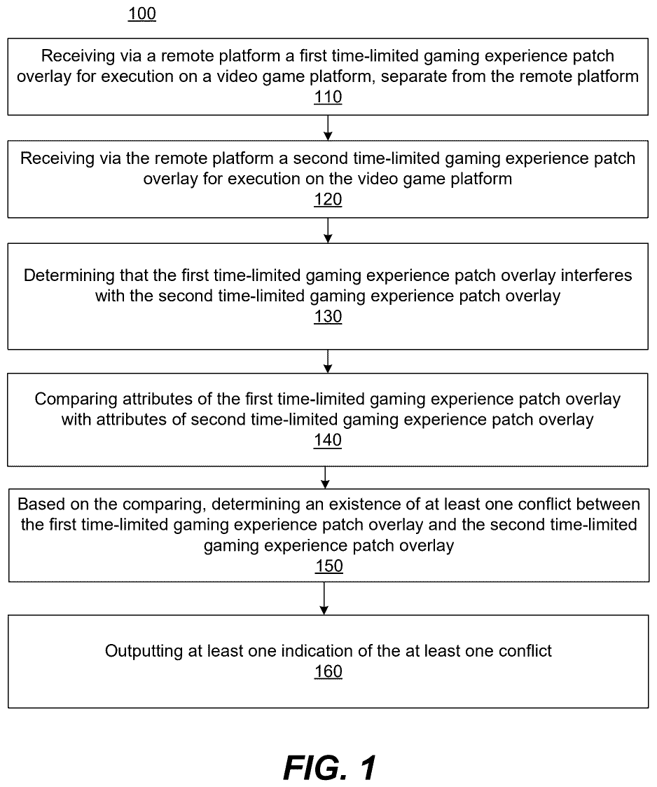

The operations performed by the at least one processor may mirror the steps of the methods described herein (e.g., method 100, as illustrated in FIG. 1). It will be understood that the steps or operations described herein may be duplicated, omitted, executed in any order, or modified to use in various situations. According to disclosed embodiments, and as exemplified in step 110 of FIG. 1, the operations may include receiving via a remote platform a first time-limited gaming experience patch overlay for execution on a video game platform, separate from the remote platform. The term “receiving” refers to retrieving or accessing data that is stored, e.g., on a server or storage device associated with a remote platform. A remote platform may refer to a computerized platform that operates separately from a particular video game platform. The remote platform may be accessible to, e.g., a developer who wishes to configure changes to the gameplay of a particular video game platform by creating one or more gaming experience patch overlays (as described elsewhere herein). The remote platform may be helpful to the developer who wishes to make changes to particular players'gameplay experiences without affecting the underlying code of the video game itself (e.g., without modifying the video game platform or the code associated with the video game itself, and instead configuring the changes via the remote platform). It follows that a video game platform, in this context, may refer to a platform that contains the original video game code and controls the original gameplay of the video game. The remote platform may communicate with the video game platform to insert (e.g., execute) each configured patch overlay on the video game platform without affecting the original video game code or interrupting the video game platform.

As exemplified in FIG. 1 at step 110, some disclosed embodiments involve receiving via a remote platform a first time-limited gaming experience patch overlay for execution on a video game platform, separate from the remote platform.

For example, receiving may involve downloading, importing, or retrieving data from a network, storage device, or another system. Receiving may refer to the process by which a user's device or client application obtains data, files, or signals transmitted from somewhere else, for example, a remote server or platform. This may include downloading content, syncing files, or accepting streamed information such as audio, video, or application updates. Although not a requirement, in some cases, this process may occur over secure network channels to maintain data integrity and confidentiality.

The term “remote platform” refers to a computing environment, system, server, or infrastructure that is physically or logically separate from the primary system or device being used. For example, a remote platform may be a cloud-based service, a dedicated server, or a distributed computing network that provides functionality or resources to other systems. In this context, a remote platform may refer to an infrastructure solution that abstracts physical hardware and provides virtualized access to enterprise systems. It may allow a system to receive services, files, or interactive sessions without being co-located with the system. It may operate through protocols such as VPN, Remote Desktop Protocol (RDP), or cloud-based interfaces, allowing users to interact with resources as if they were local. In cloud computing or SaaS environments, a remote platform may refer to a hosted service layer that delivers applications, storage, and processing capabilities to end-users via the internet. Receiving through such a platform may refer to pulling data, updates, or notifications from centralized servers managed by a provider.

The term “video game platform” refers to a hardware or software system designed to run and support video games. In the present context, video game platforms may contain and execute the original video game code and manage the core gameplay experience independently from any external remote platform. For example, a video game platform may include gaming consoles, personal computers, mobile devices, or cloud gaming services that provide the necessary infrastructure for playing video games.

The term “execution” refers to the process of running, implementing, or carrying out instructions or code on a computing system. In the present context, “execution” may refer to the process of applying a time-limited gaming experience patch overlay to a video game platform so that the new content, features, or modifications become active and accessible to players. Execution may also involve launching an in-game event triggered by the overlay, displaying new visual elements or rewards, or enabling temporary gameplay changes without modifying the underlying code of the original video game. In this context, an “in-game event triggered by the overlay” may refer to an action or occurrence within a video game that is initiated as a direct result of a patch overlay being executed. For example, a patch overlay could trigger a special challenge or unlock a limited-time quest when a player reaches a certain level. In the present context, “displaying new visual elements or rewards” may refer to the introduction of additional graphics, notifications, or reward icons that appear in the game as part of the patch overlay. For example, a patch overlay might display a new badge on the screen or notify players of a bonus prize after completing a specific task. In the present context, “enabling temporary gameplay changes without modifying the underlying code of the original video game” may refer to altering game mechanics, settings, or features for a limited period through a patch overlay, without changing the core programming of the game itself. For example, a patch overlay could temporarily increase the player's speed or unlock a new game mode for one week, all while the original game code remains untouched. Further, execution may be initiated by the video game platform after receiving the overlay from the remote platform, allowing the enhancements to seamlessly blend with the existing game experience. As further examples, execution may involve processing data, performing calculations, or rendering graphics based on programmed instructions.

The phrase “separate from” indicates that two or more entities are not the same. It may refer to distinct, independent, or not directly connected entities. For example, separate systems may operate on different hardware, use different software environments, or maintain independent data storage.

In the context of the present disclosure, “receiving via a remote platform a first time-limited gaming experience patch overlay for execution on a video game platform, separate from the remote platform” may refer to the process of obtaining a temporary modification or addition to a gaming experience through a system that is distinct from the primary gaming platform. This configuration may allow for dynamic updates and customizations to be applied to games without altering the core game code or requiring direct access to the video game platform itself.

The remote platform may serve as an intermediary system that manages and distributes these patch overlays to various video game platforms. By keeping the remote platform separate from the video game platform, the system may provide flexibility in updating and customizing gaming experiences across different gaming systems or devices.

As exemplified in FIG. 1 at step 120, some disclosed embodiments involve receiving via the remote platform a second time-limited gaming experience patch overlay for execution on the video game platform, separate from the remote platform (as described in more detail above). It will be understood that the remote platform may continue to receive (or accumulate) current and future data (including but not limited to additional relevant patch overlays) in a similar fashion, as additional patch overlays are configured via the remote platform. The term “configure” refers to the process of setting up, arranging, or customizing the parameters, options, or features of a system, platform, or component to achieve desired functionality or behavior. For example, in the present context, configuring may involve a developer using a remote platform to set specific rules for a gaming experience patch overlay, such as adjusting the duration of a time-limited event, selecting which players receive certain in-game rewards, or enabling or disabling particular features for a video game platform without modifying the original game code. Additionally, configuring may include specifying how multiple patch overlays should interact or establishing priorities for which overlays take effect when conflicts arise.

The term “time-limited gaming experience patch overlay” can be understood as described and exemplified previously. “Second” time-limited gaming experience patch overlay refers to a time-limited gaming experience patch overlay that is distinct from the previously-described first time-limited gaming experience patch overlay. For example, it may refer to an additional temporary modification or enhancement to a gaming experience that is distinct from the first time-limited gaming experience patch overlay. For example, a second time-limited gaming experience patch overlay may introduce different gameplay elements, visual changes, or rewards that are applied to the game for a specific duration.

In the context of the present disclosure, receiving a second time-limited gaming experience patch overlay via the remote platform involves the system obtaining or acquiring an additional set of temporary modifications or enhancements for the gaming experience. This second patch overlay may be designed to work in conjunction with or independently from the first patch overlay, potentially targeting different aspects of the game or different player segments.

Although not a requirement, the process of receiving the second time-limited gaming experience patch overlay may involve similar mechanisms as those used for the first patch overlay. For example, the remote platform may download, retrieve, or accept the second patch overlay data from a content management system, developer portal, or other source of game modifications.

By receiving multiple time-limited gaming experience patch overlays, the system may enable more complex and varied modifications to the gaming experience. This approach may allow for layered changes, sequential events, or diverse experiences tailored to different player groups or game scenarios.

The separation between the remote platform and the video game platform in this context remains consistent with the architecture described for the first patch overlay. This separation may continue to provide flexibility in managing and distributing multiple patch overlays across various gaming systems or devices without directly altering the core game code on the video game platform.

As exemplified in FIG. 1 at step 130, some disclosed embodiments involve determining that the first time-limited gaming experience patch overlay interferes with the second time-limited gaming experience patch overlay.

The term “determining” refers to the process of evaluating, analyzing, or assessing information to reach a conclusion or make a decision. For example, determining may involve comparing data, applying algorithms, or using logical reasoning to identify patterns, relationships, or conflicts between different elements.

The term “interfere” refers to a situation where two or more elements interact in a way that disrupts, hinders, or conflicts with their intended functions or effects. For example, interference may occur when multiple processes attempt to access the same resource simultaneously, leading to conflicts or unexpected behavior. In the present context, interfering may refer to a situation where two or more patch overlays modify the same part of the game in ways that are incompatible or contradictory, leading to unintended or disruptive results in the game or to the player experience. For example, a first patch overlay may interfere with a second patch overlay if they offer a different reward based on the same in-game event, or at the same time within a game. As another example, patch overlays may interfere with one another if they provide contradictory notifications (e.g., consecutively) to a player.

In the context of time-limited gaming experience patch overlays, determining interference may involve analyzing the attributes, actions, and effects of multiple patch overlays to identify potential conflicts or incompatibilities. In the present context, “attributes” may include specific parameters or properties of a patch overlay, such as the duration of its effect, the player groups it targets, or the types of rewards it grants. In the present context, “actions” may encompass the presentation of in-game rewards, the activation or deactivation of particular features, or the initiation of special events in response to triggers or conditions. In the present context, “effects” may refer to the resulting changes in the gaming experience, such as granting players exclusive items, altering gameplay mechanics, displaying notifications, or providing visual enhancements during the time-limited event. This process may help ensure that different patch overlays can coexist without negatively impacting the overall gaming experience or causing unintended consequences.

The system may employ various techniques to determine interference between patch overlays. For example, it may compare the triggers, conditions, and actions associated with each patch overlay to identify overlapping or conflicting elements. In this context, “triggers” may refer to specific in-game events or occurrences that initiate a response from a patch overlay. For example, a trigger could be a player reaching a certain score, defeating a boss, or completing a particular objective. In this context, “conditions” may refer to predefined criteria or circumstances that must be met to activate a patch overlay's action or effect. For example, a condition could be a player maintaining a winning streak, entering a designated game zone, or achieving a milestone within the game. In this context, “actions” may refer to the operations or behaviors executed by a patch overlay in response to detected triggers or satisfied conditions. For example, an action could involve presenting a reward, enabling a special feature, or displaying a notification to the player.

The system may also analyze the timing and duration of each patch overlay to detect potential conflicts in their execution schedules. The term “execution schedule” refers to a predefined timetable or sequence that determines when specific actions, events, or modifications are carried out within a gaming experience. For example, in the present context, an execution schedule may specify the precise times or intervals at which a patch overlay is applied, activated, or removed from the game environment. It could also outline when particular rewards are distributed, when special features become available, or when notifications are presented to players during an event. Another example might include scheduling the activation of a second patch overlay to begin immediately after the first overlay concludes, or setting two or more patch overlays to operate simultaneously but at different times of day to target different players or player groups.

Additional disclosed embodiments involve the at least one action including presentation of at least one reward and wherein the at least one conflict includes presentation of multiple rewards for a common detected trigger.

The term “reward” refers to any form of incentive, benefit, or positive reinforcement provided to a player within a gaming experience. For example, rewards may include in-game currency, items, experience points, unlockable content, or other virtual assets that enhance the player's experience or progress in the game. The rewards can take several forms. From a gameplay perspective, they may include functional advantages such as power-ups, in-game currency, or access to new levels that enhance progression.

In this context, “power-ups” may refer to special in-game items or abilities that temporarily enhance a player's performance or provide unique advantages during gameplay. For example, a power-up could grant increased speed, invincibility, or stronger attacks for a limited period when collected by a player. In this context, “in-game currency” may refer to a digital resource that players can earn, collect, or purchase to exchange for virtual goods or benefits within the game. For example, in-game currency could be used to buy new character skins, unlock special items, or access premium content. In this context, “access to new levels” may refer to the ability for players to enter and play additional stages, areas, or challenges beyond the standard content. For example, access to new levels could be granted as a reward for completing certain missions or achieving specific milestones in the game.

In the present context, “enhancing progression” may include granting players power-ups that allow them to overcome challenging obstacles more easily, awarding in-game currency that can be used to unlock new levels or abilities, or providing access to exclusive missions that accelerate a player's advancement through the game. These enhancements help players move forward in their gaming journey by offering tangible benefits or shortcuts tied to their achievements or participation in time-limited events.

Rewards can also be cosmetic or status-based, offering visual customizations like character skins, badges, or achievement titles that showcase player accomplishments without altering core mechanics. Additionally or alternatively, rewards may involve psychological feedback, such as congratulatory messages, score increments, or celebratory animations that reinforce positive behavior. In time-limited gaming experiences, rewards may include exclusive items, seasonal bonuses, or rare collectibles available only during a defined event window, creating urgency and encouraging participation. Overall, a reward may be any tangible or intangible outcome designed to motivate engagement and provide value to the player.

The term “common detected trigger” refers to a specific event or condition that activates multiple patch overlays simultaneously. For example, a common detected trigger may be a player reaching a certain level, completing a specific task, or logging in at a particular time. In this context, “common detected trigger” may refer to a specific event or condition within the game that both patch overlays are designed to respond to. A trigger may typically be an in-game occurrence—such as completing a level, achieving a score milestone, defeating a boss, or performing a certain action—that activates predefined behaviors or rewards. Common detected trigger may mean that the same event has been identified by both overlays as a point for initiating their respective actions. For example, if both overlays are programmed to grant a reward when a player reaches 1,000 points, that score milestone may be the common detected trigger. The conflict arises because multiple overlays attempt to act on the same trigger, potentially causing overlapping or contradictory outcomes like presenting two different rewards for one achievement.

“Conflict,” in this context, refers to a situation where two time-limited gaming experience patch overlays cannot operate together without causing unintended or undesirable effects. This may happen when both overlays attempt to modify the same game element, respond to the same trigger, or present overlapping actions—such as granting multiple rewards for a single event. A conflict can manifest as duplicated rewards, inconsistent game states, performance issues, or even system errors that disrupt gameplay. It may indicate incompatibility between the overlays'instructions, conditions, or outcomes, requiring detection and resolution to maintain a smooth and predictable gaming experience. A conflict may arise when multiple patch overlays attempt to present different rewards in response to the same trigger. This situation may lead to confusion for the player, unintended gameplay imbalances, or technical issues in reward distribution.

Additional disclosed embodiments involve the at least one action including presentation of at least one reward and wherein the at least one conflict includes presentation of multiple rewards for a common detected condition.

The term “common detected condition” refers to a specific set of circumstances or criteria that, when met, activate multiple patch overlays. For example, a common detected condition may be a player maintaining a certain win streak, achieving a specific in-game status, or meeting particular engagement metrics. In this context, a common detected condition may refer to a specific in-game state or circumstance that both patch overlays recognize as a trigger for their respective actions. A condition may be a predefined requirement or scenario, such as reaching a certain score, completing a mission, entering a specific game zone, or achieving a milestone. Common detected condition may mean that the same underlying situation has been identified by both overlays as meeting their activation criteria. For example, if both overlays are programmed to respond when a player defeats a boss character, that event is the common detected condition. A conflict arises because multiple overlays attempt to act on this shared condition, potentially resulting in overlapping or contradictory outcomes—such as presenting multiple rewards for one achievement. Thus, similar to conflicts arising from common triggers, conflicts related to common conditions may occur when multiple patch overlays attempt to present different rewards based on the same condition being met. This may result in overlapping or conflicting reward presentations, potentially disrupting the intended player experience.

Additional disclosed embodiments involve the at least one conflict including contradictory triggers for a common reward.

The term “contradictory triggers” refers to different events or conditions that activate the same reward but are mutually exclusive or inconsistent with each other. For example, contradictory triggers may include rewarding a player for both winning and losing a match, or for both completing a task quickly and taking a long time to finish it. Contradictory triggers may mean that two or more activation conditions are logically inconsistent or mutually exclusive but are linked to the same reward. When triggers are contradictory, they impose conflicting requirements for the same outcome. For example, one overlay might require the player to complete a level without losing health, while another requires the player to lose health at least once, yet both aim to grant the same reward. Because these conditions cannot be satisfied simultaneously, the system faces ambiguity about when or whether to present the reward, creating a conflict that needs resolution. In this context, a conflict may arise when multiple patch overlays define contradictory triggers for the same reward. This situation may lead to logical inconsistencies in the reward system, potentially confusing players or creating exploitable loopholes in the game mechanics.

Additional disclosed embodiments involve the at least one conflict including an identification of a same player in the first group and in the second group.

The term “identification” refers to the process of recognizing, distinguishing, or categorizing an entity based on specific characteristics or criteria. For example, identification may involve assigning a unique identifier, classifying based on attributes, or associating an entity with particular groups or categories.

In the context of time-limited gaming experience patch overlays, a conflict may arise when the same player is identified as belonging to multiple groups that are intended to receive different, potentially incompatible patch overlays. This situation may occur due to overlapping player segmentation criteria or changes in player behavior over time.

The system (e.g., system 200) may implement conflict resolution strategies to address these various types of conflicts. In the present context, “conflict resolution strategies” may include implementing rules to prioritize one patch overlay over another when both attempt to modify the same game element, merging overlapping reward presentations into a single unified outcome, or temporarily disabling one overlay when a conflict is detected. Additional strategies may involve adjusting activation conditions so that only one overlay responds to a common trigger, or using a sandbox computing environment to pre-test overlays and identify incompatibilities before deployment.

As further examples, the system (e.g., system 200) may prioritize certain patch overlays based on predefined rules, merge compatible rewards, or prompt developers to manually resolve conflicts before deploying the patch overlays. By identifying and addressing these conflicts, the system may help maintain a consistent and enjoyable gaming experience for all players while allowing for dynamic, targeted modifications through time-limited patch overlays.

As exemplified in FIG. 1 at step 140, some disclosed embodiments involve comparing attributes of the first time-limited gaming experience patch overlay with attributes of second time-limited gaming experience patch overlay. “Comparing” refers to the process of examining and evaluating changes introduced by different patch overlays to identify any potential conflicts or unintended overlaps between two or more patch overlays. Comparing, in this context, may involve analyzing the modifications made by each patch overlay, such as changes to files, scripts, or assets, and determining, based on the analyzing, whether the modifications affect the same elements of the video game in conflicting or incompatible ways. Attributes, in the present context, may refer to the specific characteristics or properties of each patch overlay that define what that patch overlay changes, adds, or modifies within the video game. Example attributes may include version numbers, targeted in-game elements, modifications data, dependency data, compatibility data, priority level data, release data, or size data.

Some disclosed embodiments involve comparing attributes of the first time-limited gaming experience patch overlay with attributes of second time-limited gaming experience patch overlay.

The term “comparing” may be understood as described and exemplified previously. In this context, comparing may involve analyzing data structures, evaluating parameters, or assessing characteristics to determine how items relate to each other.

The term “attributes” may be understood as described and exemplified previously. In this context, attributes of a time-limited gaming experience patch overlay may include its duration, target player group, activation triggers, associated rewards, or impact on gameplay mechanics. In this context, “attributes” may also refer to the defining properties or characteristics of each time-limited gaming experience patch overlay that influence its behavior and interaction with the game. These attributes may include triggers and conditions that specify when an overlay activates, actions that define what occurs upon activation (such as presenting rewards), timing parameters that control start and end periods, and resource requirements like memory or asset usage. Attributes may also encompass developer-defined rules, priority levels, and reward specifications that determine how content is delivered to the player. By comparing these attributes, a system (e.g., system 200) may identify overlaps, contradictions, or incompatibilities that could lead to conflicts, ensuring smooth integration of multiple overlays within the gaming environment.

In the context of the present disclosure, comparing attributes of time-limited gaming experience patch overlays may involve analyzing and evaluating the specific characteristics of different patch overlays to identify potential conflicts, compatibilities, or interactions between them. This comparison process may help ensure that multiple patch overlays can coexist and function as intended within the gaming environment without causing unintended consequences or disruptions to the player experience.

The system may employ various techniques to compare attributes of different patch overlays. For example, it may use data structures to represent the attributes of each patch overlay and apply comparison algorithms to identify matching or conflicting elements. The comparison process may involve examining factors such as activation timing, target player segments, reward structures, or modifications to game mechanics.

Additional disclosed embodiments involve the comparing being performed in a sandbox computing environment.

The term “sandbox computing environment” refers to a controlled, isolated virtual space within a computer system where software or code can be tested, evaluated, or executed without affecting the main operating environment or other systems. For example, a sandbox environment may provide a simulated version of a gaming platform where patch overlays can be tested for compatibility and performance before being deployed to the live game environment.

In the context of comparing time-limited gaming experience patch overlays, a sandbox computing environment may offer several advantages. It may allow for thorough testing and analysis of patch overlay interactions without risking disruptions to the live gaming experience. The sandbox environment may simulate various game scenarios, player interactions, and timing conditions to identify potential conflicts or issues that may arise when multiple patch overlays are applied simultaneously.

Additional disclosed embodiments involve the comparing being performed prior to execution on the video game platform of at least one of the first time-limited gaming experience patch overlay and the second time-limited gaming experience patch overlay.

In this context, “prior to execution” refers to performing the comparison step before either the first or second time-limited gaming experience patch overlay is actually run or applied on the video game platform. This means the system may analyze and evaluate the attributes of the overlays in advance, within a preparatory phase, to detect potential conflicts before they impact gameplay. Performing the comparison prior to execution on the video game platform may serve as a proactive measure to identify and address potential conflicts before they can impact the player experience. This approach may allow for adjustments, optimizations, or conflict resolutions to be made to the patch overlays before they are deployed to the live gaming environment.

The system (e.g., system 200) may include a sandbox computing environment for comparing patch overlays before execution on the video game platform. This sandbox environment may provide a controlled testing ground where the attributes and behaviors of different patch overlays can be analyzed and evaluated in isolation from the live game. By utilizing a sandbox environment, the system may simulate various scenarios and conditions to identify potential conflicts or interactions between patch overlays without risking disruptions to the actual gaming experience.

For example, the sandbox environment may allow developers or system administrators to load multiple patch overlays, simulate their activation under different game states or player conditions, and observe how they interact with each other and with simulated game elements. This process may help identify issues such as overlapping rewards, conflicting triggers, or unintended gameplay effects that could arise from the simultaneous application of multiple patch overlays.

By performing these comparisons and tests in a sandbox environment prior to execution on the video game platform, the system may enhance the reliability and stability of the patch overlay implementation. This approach may help ensure that when patch overlays are deployed to the live game environment, they function as intended and provide a seamless, conflict-free experience for players.

As exemplified in FIG. 1 at step 150, some disclosed embodiments involve determining, based on the comparing step, an existence of at least one conflict between the first time-limited gaming experience patch overlay and the second time-limited gaming experience patch overlay. A conflict, may be understood as described and exemplified previously. As an example, based on a comparison of dependency data associated with a first patch overlay and a second patch overlay, a conflict comprising incompatibilities between the dependency data (e.g., different rewards being offered after the same in-game event to the same player) may be determined to exist.

The term “existence” refers to the state or fact of being present, occurring, or being real. For example, existence may involve the presence of a specific condition, relationship, or phenomenon within a system or environment.

In the context of the present disclosure, “existence of at least one conflict” refers to the identification or recognition of one or more incompatibilities, contradictions, or interferences between different elements or components of a system. For example, a conflict may exist when two patch overlays attempt to modify the same game element in incompatible ways or when they provide contradictory instructions for player interactions.

Based on the comparison of attributes between the first and second time-limited gaming experience patch overlays, the system may analyze the results to determine if any conflicts exist. This process may involve evaluating the potential interactions between the patch overlays and assessing whether their combined effects could lead to unintended consequences or disruptions in the gaming experience.

The system may employ various algorithms or decision-making processes to determine the existence of conflicts. For example, it may use rule-based systems, pattern matching, or machine learning techniques to identify potential conflicts based on predefined criteria or learned patterns from historical data.

Additional disclosed embodiments involve the operations further comprise predicting a potential impact of the at least one conflict, and outputting the prediction.

The term “predicting” refers to the process of estimating or forecasting future outcomes, behaviors, or effects based on available data, patterns, or models. For example, predicting may involve using statistical analysis, machine learning algorithms, or expert knowledge to anticipate potential results or consequences.

The term “potential impact” refers to the possible effects, consequences, or outcomes that may result from a particular action, event, or condition. For example, a potential impact may include changes in player behavior, alterations to game balance, or technical issues arising from conflicting patch overlays.

In the context of time-limited gaming experience patch overlays, predicting a potential impact of conflicts may involve analyzing how the identified conflicts could affect various aspects of the gaming experience. This may include assessing potential effects on gameplay mechanics, player engagement, system performance, or other relevant factors.

The system may use various techniques to predict potential impacts, such as simulation models, historical data analysis, or expert systems. For example, it may simulate the application of conflicting patch overlays in a virtual environment to observe potential outcomes or analyze past instances of similar conflicts to infer likely impacts.

The term “outputting” refers to the process of sending, displaying, or otherwise transferring data or information from one system, application, or device to another. For example, outputting may include generating a report summarizing conflict predictions, displaying relevant notifications on a user interface for developers or administrators, exporting data to a file for record-keeping, or transmitting information to another system for further analysis or action. In the present context, outputting may involve presenting conflict details to stakeholders or feeding data into automated processes for conflict resolution. For example, outputting the prediction may involve generating a report, displaying information on a user interface, or sending notifications to relevant stakeholders. This output may help developers or system administrators make informed decisions about how to address or mitigate the identified conflicts.

Additional disclosed embodiments involve analyzing player feedback, engagement metrics, or performance data to prioritize conflict resolution based thereon.

The term “player feedback” refers to information, opinions, or responses provided by game players regarding their experiences, preferences, or issues encountered during gameplay. For example, player feedback may include comments, ratings, or survey responses related to specific game features or overall satisfaction. Player feedback may include anything from subjective impressions to objective bug reports, covering visual, auditory, and haptic cues, as well as strategic suggestions for game improvement.

The term “engagement metrics” refers to quantitative measures used to assess how players interact with and participate in a game. For example, engagement metrics may include session length, frequency of play, in-game purchases, or social interactions within the game. These metrics may also include actions such as clicks, likes, shares, comments, time spent on a page, session duration, scroll depth, and conversion rates. They may be designed to assess the depth and quality of user involvement, providing insights into whether audiences are actively participating, finding value, and forming meaningful connections with a brand or platform.

The term “performance data” refers to information about how well a system, application, or game operates under various conditions. For example, performance data may include metrics such as frame rate, load times, server response times, or error rates.

The term “prioritize” refers to the process of arranging or dealing with tasks or issues in order of importance or urgency. For example, prioritizing may involve ranking conflicts based on their potential impact or the resources required to resolve them.

In the context of conflict resolution for time-limited gaming experience patch overlays, analyzing player feedback, engagement metrics, and performance data may provide valuable insights into which conflicts have the most significant impact on the player experience or system stability. This analysis may help determine which conflicts should be addressed first or given more resources for resolution.

The system may employ various data analysis techniques to process and interpret the collected information. For example, it may use sentiment analysis on player feedback, trend analysis on engagement metrics, or anomaly detection on performance data to identify patterns or issues related to specific conflicts.

By prioritizing conflict resolution based on this analysis, the system may help ensure that the most critical or impactful conflicts are addressed promptly, potentially improving overall player satisfaction and system performance. This approach may also allow for more efficient allocation of development resources by focusing efforts on resolving conflicts that have the greatest impact on the gaming experience.

As exemplified in FIG. 1 at step 160, some disclosed embodiments involve outputting at least one indication of the at least one conflict. Outputting may be understood as described and exemplified previously. In this context, outputting may involve, e.g., presenting data to a user, exporting data to a file, transmitting data to another system, or feeding data into another process for further implementation.

Some disclosed embodiments involve outputting at least one indication of the at least one conflict.

The term “outputting” may be understood as described and exemplified previously. In this context, outputting may involve generating a visual display on a screen, producing an audio signal, creating a data file, or sending a notification to a user or system.

The term “indication” refers to a sign, signal, or piece of information that points to or suggests the existence, presence, or nature of something. For example, an indication may be a message, alert, highlight, or other form of communication that draws attention to or provides information about a particular condition or event.

In the context of the present disclosure, “outputting at least one indication of the at least one conflict” may refer to the process of communicating or presenting information about identified conflicts between time-limited gaming experience patch overlays. This output may serve to alert developers, system administrators, or other relevant parties about potential issues that may arise from the simultaneous application of multiple patch overlays.

The system may employ various methods to output indications of conflicts. For example, it may generate visual alerts on a user interface, send email notifications, create log entries, or trigger automated system messages. The output may include details about the nature of the conflict, the specific patch overlays involved, and potential impacts on the gaming experience.

Additional disclosed embodiments involve suggesting a conflict resolution.

The term “suggesting” refers to the act of proposing, recommending, or offering an idea, solution, or course of action. For example, suggesting may involve providing options, recommendations, or guidance based on analysis or predefined criteria.

The term “conflict resolution” refers to the process of finding a solution or compromise to address a disagreement, incompatibility, or problem between two or more elements. For example, a conflict resolution may involve modifying parameters, prioritizing actions, or implementing alternative strategies to eliminate or mitigate conflicts.

In the context of time-limited gaming experience patch overlays, suggesting a conflict resolution may involve proposing specific actions or modifications to address identified conflicts between patch overlays. The system may analyze the nature of the conflict and provide recommendations for resolving it based on predefined rules, historical data, or machine learning algorithms.

For example, the system may suggest adjusting the timing or duration of conflicting patch overlays, modifying reward structures to avoid duplication, or prioritizing one patch overlay over another based on specific criteria. These suggestions may be presented alongside the conflict indication to provide immediate guidance for addressing the issue.

Additional disclosed embodiments involve pausing the first time-limited gaming experience patch overlay and the second time-limited gaming experience patch overlay when the at least one conflict is identified, and resuming operation of the first time-limited gaming experience patch overlay and the second time-limited gaming experience patch overlay when the at least one conflict is resolved.

The term “pausing” refers to the act of temporarily stopping or suspending an action, process, or operation. For example, pausing may involve halting the execution of a program, interrupting a data stream, or delaying the application of changes to a system.

The term “resuming” refers to the act of continuing or restarting an action, process, or operation that has been previously paused or interrupted. For example, resuming may involve reactivating a suspended program, reinitiating a data stream, or reapplying changes to a system.

In the context of time-limited gaming experience patch overlays, pausing and resuming operations may provide a mechanism for managing conflicts without permanently disabling the affected patch overlays. When a conflict is identified, the system may temporarily suspend the execution of the conflicting patch overlays to prevent potential issues in the gaming experience.

The pausing operation may involve temporarily disabling the triggers, conditions, or actions associated with the conflicting patch overlays. This suspension may prevent the patch overlays from affecting the game state or player experience while the conflict is being addressed.

Once the conflict is resolved, the system may resume the operation of the previously paused patch overlays. The resuming operation may involve reactivating the triggers, conditions, and actions associated with the patch overlays, allowing them to once again influence the gaming experience.

By implementing a pause and resume mechanism, the system may provide flexibility in managing conflicts between patch overlays. This approach may allow for real-time conflict resolution without permanently removing or altering the patch overlays, potentially preserving their intended functionality once conflicts are addressed.

The system may include functionality to pause conflicting patch overlays and resume them when conflicts are resolved. This feature may provide a dynamic approach to conflict management, allowing for temporary suspension of problematic patch overlays while maintaining their potential for future use. By pausing conflicting overlays, the system may prevent immediate negative impacts on the gaming experience while providing time for conflict resolution. Once conflicts are resolved, either through automated processes or manual intervention, the ability to resume paused overlays may ensure that valuable gaming experience modifications are not permanently lost due to temporary conflicts.

In some disclosed embodiments, the first time-limited gaming experience patch overlay and the second time-limited gaming experience patch overlay may include developer-defined triggers and conditions. Developer-defined triggers and conditions refer to settings, rules, or other criteria that are determined and configured by the game developers to control how the patch overlay functions. Triggers may be understood as described and exemplified previously. In this context, triggers may refer to, e.g., the starting points or cues that cause the patch overlay to be applied or become visible in a game. Triggers may thus be the mechanisms that prompt the game to execute the changes defined by the patch overlay. Exemplary triggers may include completing a level or other in-game stage, achieving a milestone, a time-based activation, or another player interaction within the game. In some embodiments, triggers may be further associated with one or more conditions.

Conditions may be understood as described and exemplified previously. In this context, conditions may refer to the additional criteria or requirements that must be met for a trigger to in fact be activated (e.g., for the patch overlay to be presented to the player). Conditions may thus define any additional circumstances under which the patch overlay is to be applied (and otherwise, the patch overlay may not be applied even in the case of an occurring trigger). Conditions may also be used to further specify the context or environment in which the trigger is to cause the patch overlay to be applied. Exemplary conditions may include level progression, time frame, player status, or system state. In some embodiments, the first time-limited gaming experience patch overlay and the second time-limited gaming experience patch overlay may further include at least one action resulting from the developer-defined triggers and conditions.

Actions may be understood as described and exemplified previously. In this context, actions may refer to specific changes to the gaming experience that occur as a direct result of a trigger being activated and/or a condition being satisfied. Actions may thus be the outcomes or effects that are implemented once predefined criteria are met, leading to the application of in-game modifications as defined by further parameters of the patch overlay. Exemplary actions may include applying content, displaying information, activating a feature, modifying a game state, sending a notification, starting an event, or logging data.

In some embodiments, the at least one action may include presentation of at least one reward and the at least one conflict may include presentation of multiple rewards for a common detected trigger. The terms “reward” and “common detected trigger” may be understood as described and exemplified previously. A reward, in this context, may refer to an action (as defined above) that includes a specific benefit, item, or incentive given to a player. A common detected trigger, in this context, may refer to a trigger (as defined above) that is identified to exist in at least two separate places (e.g., in two distinct patch overlays).

In some embodiments, the at least one action may include presentation of at least one reward and the at least one conflict may include presentation of multiple rewards for a common detected condition. A common detected condition refers to a condition (as described and exemplified previously) that is identified to exist in at least two separate places (e.g., in two distinct patch overlays). For example, a common detected condition may include a requirement that the player has reached a certain level, achieved a specific milestone, or is within a designated time frame for the patch overlay to be applied.

In some embodiments, the at least one conflict may include contradictory triggers for a common reward. A common reward refers to a reward (as described and exemplified previously) that is identified to exist in at least two separate places (e.g., in two distinct patch overlays). Contradictory triggers refer to two or more triggers (as described and exemplified previously) that are incompatible with one another. As an example, a first patch overlay may include a trigger for a reward (e.g., 5 points) upon user login, and a second patch overlay may include a trigger for a contradictory reward of, e.g., 1 point, upon the same user login. The different rewards based on the same in-game event (i.e., user login) may therefore represent exemplary contradictory triggers for a common reward (e.g., points). In another example, contradictory triggers for a common reward may include a first trigger that causes a reward offering and a second trigger that causes the removal of that same reward.

Some disclosed embodiments involve receiving a selection of a first group of players for application of the first time-limited gaming experience patch overlay and a second group of players for application of the second time-limited gaming experience patch overlay. In some embodiments, receiving the selections (e.g., via user input, or via automation) may occur via the remote platform. Groups of players refer to sets comprising one or more players of a video game, wherein each set comprises players having at least one similar attribute in relation to the video game. Through the selection of groups of players, the remote platform (or a user thereof) may configure different time-limited gaming experience patch overlays for different players, e.g., by assigning the players into various groups based on shared attributes.

In some embodiments, the at least one conflict may include an identification of the same player in the first group and in the second group. It will be understood that the same player may be part of more than one group; however, in certain situations, the same player being part of two groups may create a conflict. For example, it may be desired that the same player is not included in both: (1) a group that receives a reward for logging in after being dormant for a given period of time, and (2) a group that receives a reward for logging in without being dormant for a given period of time. The system (or at least one processor) may be configured to detect conflicts based on the identification of such overlapping groupings of a player.

In some embodiments, the operations may further comprise suggesting a conflict resolution. A conflict resolution may be understood as described and exemplified previously. Continuing the example above, suggesting a conflict resolution may include providing a recommendation to remove a player from one (or both) of the first and second groups such that such overlapping groupings no longer exist. Another exemplary conflict resolution that may be suggested is a notification to a user that such a conflict exists and allowing the user to override the warning or ignore the notification.

In some embodiments, the operations may further comprise predicting a potential impact of the at least one conflict, and outputting the prediction. Predicting may be understood as described and exemplified previously. In this context, predicting may involve analyzing how upcoming patch overlays might interact with existing game elements, other patch overlays, or system configurations in an attempt to foresee problems before they occur. A potential impact may be understood as described and exemplified previously. A potential impact may involve, e.g., assessing how each patch overlay (or feature thereof) might influence various aspects of a video game or a gaming experience, such as gameplay, performance, user experience, or system stability.

Some disclosed embodiments involve analyzing player feedback, engagement metrics, or performance data to prioritize conflict resolution based thereon. Player feedback refers to information, opinions, or reactions provided by players of a video game, based on their gaming experiences. Player feedback may include data related to gameplay mechanics, story, graphics, performance, engagement, or other subjective player data. Player feedback may serve as a valuable resource for understanding how players perceive the video game and the patch overlays, identifying areas for improvement, and making informed decisions about future updates or changes (e.g., conflict resolution and the prioritization of various solutions for each detected conflict). Player feedback may include player opinions on bugs, gameplay experience, narrative, graphics, sound, user experience, user interface, performance. Engagement metrics refers to data points or measurements used to assess how players interact with (or are involved in) a game. Engagement metrics may help understand player behavior, determine a game's popularity, or identify areas that may need improvement to increase player retention and satisfaction (such as by prioritizing conflict resolution tasks). Engagement metrics may include user state (e.g., active, dormant), session length, session frequency, retention rate, churn rate, in-game interactions, time to first action, social interactions, progression metrics, monetization metrics, and other data that is indicative of player engagement. Performance data refers to quantitative information that measures how well a video game runs in different hardware and software environments. Performance data may help ensure that a video game provides a smooth, responsive, and enjoyable experience across a wide range of devices and configurations (each of which may have different conflict resolution tasks, which may be prioritized). Performance data may include information on frame rate, load time, memory usage, processor utilization, latency, network performance, battery consumption, and other performance-based factors. Prioritizing, as used herein, may refer to a process of determining the order of importance or urgency for various tasks, issues, or updates (e.g., for various conflict resolutions). By focusing, e.g., on the most critical conflict resolution tasks first, the most impactful or time-sensitive aspects may be addressed before others.

In some embodiments, the comparing may be performed prior to execution on the video game platform of at least one of the first time-limited gaming experience patch overlay and the second time-limited gaming experience patch overlay. By performing the comparing prior to execution on the video game platform, users may further confirm that conflicts between patch overlays do not exist before releasing and implementing those patch overlays via execution on the video game platform. Such comparing prior to execution may occur in a sandbox environment and/or via the remote platform (or another environment associated with the remote platform).

In some embodiments, the operations may further comprise pausing the first time-limited gaming experience patch overlay and the second time-limited gaming experience patch overlay when the at least one conflict is identified, and resuming operation of the first time-limited gaming experience patch overlay and the second time-limited gaming experience patch overlay when the at least one conflict is resolved. Pausing refers to temporarily halting the application or effect of a specific patch overlay. When paused, any changes or modifications to the gaming experience that are introduced by that patch overlay are suspended, allowing the video game platform and the remote platform to run without the patch overlay until that patch overlay is resumed or reapplied (e.g., after the detected conflict is resolved). It will be understood that any number of patch overlays that have detected conflicts may be paused (either simultaneously or in a given order) and that each patch overlay may be resumed (reapplied, reactivated) when all the detected conflicts associated with each particular patch overlay are resolved.

According to another embodiment of the present disclosure, a system for performing conflict detection operations in time-limited gaming experience patch overlays may be provided. The system may include at least one processor configured to perform operations. In some embodiments, the operations performed by the at least one processor of the system may mirror the steps of the methods described herein (e.g., method 100, as illustrated in FIG. 1). It will be understood that the steps or operations described herein may be duplicated, omitted, executed in any order, or modified to use in various situations. According to disclosed embodiments, and as exemplified in FIG. 1, the operations may include the following steps: receiving via a remote platform a first time-limited gaming experience patch overlay for execution on a video game platform, separate from the remote platform (step 110); receiving via the remote platform a second time-limited gaming experience patch overlay for execution on the video game platform, separate from the remote platform (step 120); determining that the first time-limited gaming experience patch overlay interferes with the second time-limited gaming experience patch overlay (step 130); comparing attributes of the first time-limited gaming experience patch overlay with attributes of second time-limited gaming experience patch overlay (step 140); based on the comparing, determining an existence of at least one conflict between the first time-limited gaming experience patch overlay and the second time-limited gaming experience patch overlay (step 150); and outputting at least one indication of the at least one conflict (step 160) (as described elsewhere herein).

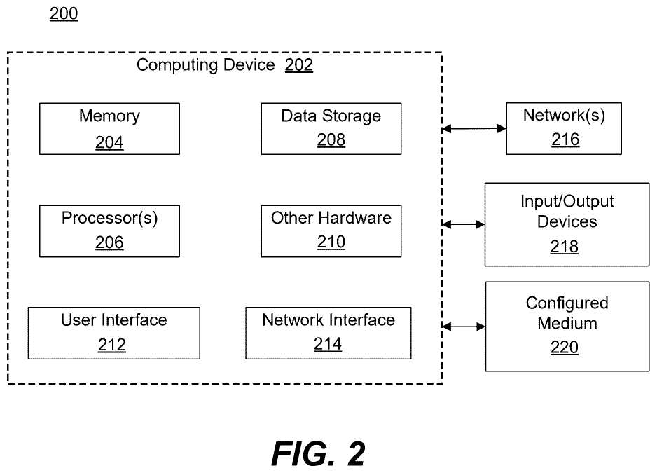

An exemplary system 200 for implementing various aspects of this disclosure is illustrated in FIG. 2. As illustrated in FIG. 2, an exemplary operating environment 200 may include a computing device 202 (e.g., a general-purpose computing device) in the form of a computer. In some embodiments, computing device 202 may be associated with a user. Components of the computing device 202 may include, but are not limited to, various hardware components, such as one or more processors 206, data storage 208, a system memory 204, other hardware 210, and a system bus (not shown) that couples (e.g., communicably couples, physically couples, and/or electrically couples) various system components such that the components may transmit data to and receive data from one another. The system bus may be any of several types of bus structures including a memory bus or memory controller, a peripheral bus, an address bus, a data bus, a control bus, and a local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 2, exemplary system 200 includes at least one computing device 202. The computing device 202 may be a uniprocessor or multiprocessor computing device. System 200 may include one or more computing devices (e.g., multiple computing devices 202) in a given computer system, which may be clustered, part of a local area network (LAN), part of a wide area network (WAN), part of a metropolitan area network (MAN), part of a wireless network, client-server networked, peer-to-peer networked within a cloud, or otherwise communicably linked. A network may include a vertical network, a chain network, a circuit network, a wheel or spoke network, a star network, or another type of network. A computer system may include an individual machine or a group of cooperating machines. A given computing device 202 may be configured for end-users, e.g., with applications, for administrators, as a server, as a distributed processing node, as a special-purpose processing device, or otherwise configured. In some embodiments, multiple computing devices 202 (e.g., a network of GPUs) may be configured together.

One or more users may interact with the computer system comprising one or more computing devices 202 by using a display, keyboard, mouse, microphone, touchpad, camera, sensor (e.g., touch sensor) and other input/output devices 218, via typed text, touch, voice, movement, computer vision, gestures, and/or other forms of input/output. An input/output device 218 may be removable (e.g., a connectable mouse or keyboard) or may be an integral part of the computing device 202 (e.g., a touchscreen, a built-in microphone). A user interface 212 may support interaction between an embodiment and one or more users. A user interface 212 may include one or more of a command line interface (CLI), graphical user interface (GUI), menu-driven user interface, voice user interface, touch user interface, form-based user interface, natural language user interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user input may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, a game port, or a universal serial bus (USB). A monitor or other type of display device may also be connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers, headphones, monitors, projectors, readers, or a printer, which may be connected through an output peripheral interface or the like.

One or more application programming interface (API) calls may be made between input/output devices 218 and computing device 202, based on input received at user interface 212 and/or from network(s) 216. As used throughout, “based on” may refer to being established or founded upon a use of, changed by, influenced by, caused by, dependent upon, or otherwise derived from. In some embodiments, an API call may be configured for a particular API, and may be interpreted and/or translated to an API call configured for a different API. As used herein, an API may refer to a defined (e.g., according to an API specification) interface or connection between computers or between computer programs. An API specification may refer to a broad and language-agnostic description of how an API functions, data types supported by the API, the fundamental design philosophy of the API, and how the API links with other APIs.

Various types of users may interact with computing device 202 via one or more API calls and/or via a direct input via input/output devices 218. System administrators, network administrators, software developers, engineers, and end-users may each be a particular type of user. Automated agents, scripts, playback software, and the like, acting on behalf of one or more people, may also constitute a type of user. Storage devices and/or networking devices may be considered peripheral equipment in some embodiments and part of a system comprising one or more computing devices 202 in other embodiments, depending on their detachability from the processor(s) 206. Other computerized devices and/or systems not shown in FIG. 2 may interact in technological ways with computing device 202 or with another system using one or more connections to a network 216 via a network interface 214, which may include network interface equipment, such as a physical network interface controller (NIC) or a virtual network interface (VIF).

Computing device 202 may include at least one logical processor 206. The at least one logical processor 206 may include circuitry and transistors configured to execute instructions from memory (e.g., memory 204). For example, the processor(s) 206 may include one or more central processing units (CPUs), control units (CUs), arithmetic logic units (ALUs), registers, clocks, Floating Point Units (FPUs), and/or Graphics Processing Units (GPUs). The computing device 202, like other suitable devices, may also include one or more computer-readable storage media, which may include, but are not limited to, memory 204 and data storage 208. Computer-readable storage media may refer to any medium capable of storing data in a format that is easily processed by a digital computer or easily readable by a mechanical device. In some embodiments, memory 204 and data storage 208 may be part of a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 220 such as a portable (i.e., external) hard drive, compact disc (CD), Digital Versatile Disc (DVD), memory stick, mobile device, tablet device, USB device, or other removable non-volatile memory medium may become functionally a technological part of the computer system when inserted or otherwise installed with respect to one or more computing devices 202, making its content accessible for interaction with and use by processor(s) 206. The removable configured medium 220 is an example of a computer-readable storage medium. Some other examples of computer-readable storage media include built-in random access memory (RAM), read-only memory (ROM), hard disks, and other memory storage devices which are not readily removable by users (e.g., memory 204).

The configured medium 220 may be configured with instructions (e.g., binary instructions) that are executable by a processor 206; “executable” is used in a broad sense herein to include machine code, interpretable code, bytecode, compiled code, and/or any other code that is configured to run on a machine, including a physical machine or a virtualized computing instance (e.g., a virtual machine or a container). For example, an executable file may be a computer file that contains an encoded sequence of instructions that a system can execute directly when instructed by a user. The configured medium 220 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 210 such as Programmable Network Devices (e.g., switches, smart network interface cards), Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), Simple Programmable Logic Devices (SPLDs), and similar components. Components of an embodiment may be grouped into interacting functional modules based on their inputs, outputs, and/or their technical effects, for example.

In addition to processor(s) 206, memory 204, data storage 208, and screens/displays, system 200 may also include other hardware 210, such as batteries, buses, power supplies, wired and wireless network interface cards, additional input devices, additional processing devices, communication devices, persistent storage devices, and motherboards, for instance. The nouns “screen” and “display” are used interchangeably herein. A display may include one or more touch screens, screens responsive to input from a pen or tablet, or screens which operate solely for output. In some embodiment, other input/output devices 218 such as human user input/output devices (screen, keyboard, mouse, tablet, microphone, speaker, motion sensor, etc.) will be present in operable communication with one or more processors 206 and memory 204.

In some embodiments, system 200 may include multiple computing devices 202 connected by network(s) 216. Networking interface equipment can provide access to network(s) 216, using components (which may be part of a network interface 214) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches including but not limited to correspondence files, accounting systems, inventory-control systems, directories, indexing systems, and query systems.

The computing device 202 may operate in a personal environment, a private environment, or a networked or cloud-computing environment using logical connections to one or more remote devices (e.g., using network(s) 216), such as a remote computer (e.g., another computing device). The remote computer may include one or more of a personal computer, a server, a router, a network PC, or a mobile device or other common network node, and may include any or all of the elements described above relative to the computer. The logical connections may include one or more LANs, WANs, virtual networks, and/or the Internet.

When used in a networked or cloud-computing environment, computing device 202 may be connected to a public or private network through a network interface controller, a physical network interface, or a network adapter (e.g., a LAN or WAN adapter). A network interface or adapter may refer to a hardware component responsible for connecting a computing device to a computer network. In some embodiments, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Computing device 202 may also include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for an artificial intelligence model, and/or an artificial intelligence model itself) and which can be accessed by the computer. Communication media may embody computer-readable instructions, data structures, program modules or other data in a modulated data signal. The term “modulated data signal” means a signal that has one or more of its characteristics set or changed in such a manner as to encode information in the signal. By way of example, and not limitation, communication media includes wired media such as a wired network, direct-wired connection, analog or digital connection, twisted pair connection, coaxial connection, ethernet, or fiber optic connection, and wireless media such as acoustic, radio frequency (RF), infrared, broadcast, cellular, microwave, satellite, and other wireless media. Combinations of the any of the above may also be included within the scope of computer-readable media. Computer-readable media may be embodied as a computer program product, such as software (e.g., including program modules) stored on non-transitory computer-readable storage media.

The data storage 208 or system memory includes computer storage media in the form of volatile and/or nonvolatile memory such as ROM and RAM. ROM may refer to a type of computer storage containing non-volatile, permanent data that, normally, can only be read, not written to or changed. RAM may refer to a form of computer memory that can be read and written to or changed in any order. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 208 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Forms of data storage may include file storage, block storage, object storage, direct-attached storage, and/or network-based storage.

According to yet another embodiment of the present disclosure, a method for performing conflict detection operations in time-limited gaming experience patch overlays may be provided. The method may be performed by a system (e.g., system 200) or at least one processor. FIG. 1 illustrates an exemplary method 100 for performing conflict detection operations in time-limited gaming experience patch overlays, consistent with disclosed embodiments. It will be understood that the steps or operations described herein may be duplicated, omitted, executed in any order, or modified to use in various situations. According to disclosed embodiments, and as exemplified in FIG. 1, method 100 may include the following steps: receiving via a remote platform a first time-limited gaming experience patch overlay for execution on a video game platform, separate from the remote platform (step 110); receiving via the remote platform a second time-limited gaming experience patch overlay for execution on the video game platform, separate from the remote platform (step 120); determining that the first time-limited gaming experience patch overlay interferes with the second time-limited gaming experience patch overlay (step 130); comparing attributes of the first time-limited gaming experience patch overlay with attributes of second time-limited gaming experience patch overlay (step 140); based on the comparing, determining an existence of at least one conflict between the first time-limited gaming experience patch overlay and the second time-limited gaming experience patch overlay (step 150); and outputting at least one indication of the at least one conflict (step 160) (as described elsewhere herein).

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A non-transitory computer readable medium containing instructions that when executed by at least one processor cause the at least one processor to perform conflict detection identification operations in time-limited gaming experience patch overlays, the operations comprising:
receiving via a remote platform a first time-limited gaming experience patch overlay for execution on a video game platform, separate from the remote platform;
receiving via the remote platform a second time-limited gaming experience patch overlay for execution on the video game platform, separate from the remote platform;
determining that the first time-limited gaming experience patch overlay interferes with the second time-limited gaming experience patch overlay;
comparing attributes of the first time-limited gaming experience patch overlay with attributes of second time-limited gaming experience patch overlay;
based on the comparing, determining an existence of at least one conflict between the first time-limited gaming experience patch overlay and the second time-limited gaming experience patch overlay; and
outputting at least one indication of the at least one conflict.

2. The non-transitory computer readable medium of claim 1, wherein the first time-limited gaming experience patch overlay and the second time-limited gaming experience patch overlay include developer-defined triggers and conditions, and further include at least one action resulting from the triggers and conditions.

3. The non-transitory computer readable medium of claim 2, wherein the at least one action includes presentation of at least one reward and wherein the at least one conflict includes presentation of multiple rewards for a common detected trigger.

4. The non-transitory computer readable medium of claim 2, wherein the at least one action includes presentation of at least one reward and wherein the at least one conflict includes presentation of multiple rewards for a common detected condition.

5. The non-transitory computer readable medium of claim 2, wherein the at least one conflict includes contradictory triggers for a common reward.

6. The non-transitory computer readable medium of claim 1, wherein the operations further include receiving a selection of a first group of players for application of the first time-limited gaming experience patch overlay and a second group of players for application of the second time-limited gaming experience patch overlay.

7. The non-transitory computer readable medium of claim 6, wherein the at least one conflict includes an identification of a same player in the first group and in the second group.

8. The non-transitory computer readable medium of claim 1, wherein the operations further comprise suggesting a conflict resolution.

9. The non-transitory computer readable medium of claim 1, wherein the operations further comprise predicting a potential impact of the at least one conflict, and outputting the prediction.

10. The non-transitory computer readable medium of claim 9, wherein the operations further comprise analyzing player feedback, engagement metrics, or performance data to prioritize conflict resolution based thereon.

11. The non-transitory computer readable medium of claim 1, wherein the comparing is performed in a sandbox computing environment.

12. The non-transitory computer readable medium of claim 1, wherein the comparing is performed prior to execution on the video game platform of at least one of the first time-limited gaming experience patch overlay and the second time-limited gaming experience patch overlay.

13. The non-transitory computer readable medium of claim 1, wherein the operations further comprise pausing the first time-limited gaming experience patch overlay and the second time-limited gaming experience patch overlay when the at least one conflict is identified, and resuming operation of the first time-limited gaming experience patch overlay and the second time-limited gaming experience patch overlay when the at least one conflict is resolved.

14. A system for performing conflict detection identification operations in time-limited gaming experience patch overlays, the system comprising:
at least one processor configured to, perform operations including:
receiving via a remote platform a first time-limited gaming experience patch overlay for execution on a video game platform, separate from the remote platform;
receiving via the remote platform a second time-limited gaming experience patch overlay for execution on the video game platform, separate from the remote platform;
determining that the first time-limited gaming experience patch overlay interferes with the second time-limited gaming experience patch overlay;
comparing attributes of the first time-limited gaming experience patch overlay with attributes of second time-limited gaming experience patch overlay;
based on the comparing, determining an existence of at least one conflict between the first time-limited gaming experience patch overlay and the second time-limited gaming experience patch overlay; and
outputting at least one indication of the at least one conflict.

15. The system of claim 14, wherein the first time-limited gaming experience patch overlay and the second time-limited gaming experience patch overlay include developer-defined triggers and conditions, and further include at least one action resulting from the triggers and conditions.

16. The system of claim 15, wherein the at least one action includes presentation of at least one reward and wherein the at least one conflict includes presentation of multiple rewards for a common detected trigger.

17. The system of claim 15, wherein the at least one action includes presentation of at least one reward, and wherein the at least one conflict includes presentation of multiple rewards for a common detected condition.

18. The system of claim 15, wherein the at least one conflict includes contradictory triggers for a common reward.

19. The system of claim 14, wherein the operations further include receiving a selection of a first group of players for application of the first time-limited gaming experience patch overlay and a second group of players for application of the second time-limited gaming experience patch overlay.

20. A method of performing conflict detection identification operations in time-limited gaming experience patch overlays, the method comprising:
receiving via a remote platform a first time-limited gaming experience patch overlay for execution on a video game platform, separate from the remote platform;
receiving via the remote platform a second time-limited gaming experience patch overlay for execution on the video game platform, separate from the remote platform;
determining that the first time-limited gaming experience patch overlay interferes with the second time-limited gaming experience patch overlay;
comparing attributes of the first time-limited gaming experience patch overlay with attributes of second time-limited gaming experience patch overlay;
based on the comparing, determining an existence of at least one conflict between the first time-limited gaming experience patch overlay and the second time-limited gaming experience patch overlay; and
outputting at least one indication of the at least one conflict.
